(19) United States
(12) Patent Application Publication
(10) Pub. No.: US 2018/0137087 A1
(43) Pub. Date: May 17, 2018

(54) METHODS, SYSTEMS, AND APPARATUS FOR GENERATING AN ITEM PUBLICATION

(71) Applicant: eBay Inc., San Jose, CA (US)

(72) Inventors: Tathagata Chakraborty, Bangalore (IN); Shriram Venkatasubramanian, Bangalore (IN)

(21) Appl. No.: 15/349,498

(22) Filed: Nov. 11, 2016

(51) Int. Cl. G06F 17/21; G06F 3/0482; G06F 3/0484; G06F 17/22; G06Q 30/06

(52) U.S. Cl. CPC G06F 17/211; G06F 3/0482; G06Q 30/0603; G06F 17/2247; G06Q 30/0641; G06F 3/04845

(57) ABSTRACT

Methods, systems, and apparatus for generating an item publication are described. Specification information for an item is obtained and an item publication is created in response to a one-click command.

### TECHNICAL FIELD

The present application relates generally to generating an item publication using determined details of a physical item and, more specifically, in one example, to generating an item publication using a one-click technique.

### BACKGROUND

Consumers are shopping online for a growing variety of products and services and may conduct searches to locate items that are available for purchase. The consumers of products and services may generally include retail consumers, distributors, small business owners, business representatives, corporate representatives, non-profit organizations, and the like. The providers of the products and/or services may include individuals, retailers, wholesalers, distributors, manufacturers, service providers, small business owners, independent dealers, and the like. The publication for an item that is available for purchase may comprise a price, a description of the product and/or service and, optionally, one or more specific terms for the offer. A seller of the item is often responsible for providing the information describing the item and for creating the publication.

### BRIEF DESCRIPTION OF THE DRAWINGS

Some embodiments are illustrated by way of example and not limitation in the figures of the accompanying drawings in which:

FIG. 1A is a network diagram depicting a client-server system, which one example embodiment may be deployed;

FIG. 1B is a block diagram illustrating publication and payment applications that, in one example embodiment, are provided as part of application server(s) in the networked system;

FIG. 1C shows a block diagram of an example system for obtaining information on an item and creating an item publication, in accordance with an example embodiment;

FIG. 2 shows a flowchart for an example method for publishing, indexing, and searching for a product and/or service, in accordance with an example embodiment;

FIG. 3 shows a block diagram of an example apparatus for determining details regarding an item and creating an item publication, in accordance with an example embodiment;

FIGS. 4A and 4B show representations of example user interfaces for creating an item publication, in accordance with an example embodiment;

FIG. 5 shows an example data structure for maintaining information associated with an item, in accordance with an example embodiment;

FIG. 6 is a flowchart for a first example method for determining details regarding an item and creating an item publication, in accordance with an example embodiment;

FIG. 7 is a flowchart for a second example method for determining details regarding an item and creating an item publication, in accordance with an example embodiment;

FIG. 8 is a block diagram illustrating a mobile device, according to an example embodiment; and

FIG. 9 is a block diagram of a machine within which instructions may be executed for causing the machine to perform any one or more of the methodologies discussed herein.

### DETAILED DESCRIPTION

In the following detailed description of example embodiments, reference is made to specific examples by way of drawings and illustrations. These examples are described in sufficient detail to enable those skilled in the art to practice these example embodiments, and serve to illustrate how the invention may be applied to various purposes or embodiments. Other embodiments of the invention exist and are within the scope of the invention, and logical, mechanical, electrical, and other changes may be made without departing from the scope or extent of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

Generally, methods, systems, and apparatus for obtaining information on an item and generating an item publication are described. In one example embodiment, the item is a device, such as a smartphone, a wearable electronic device, a tablet computer, a cellular telephone, a refrigerator, an automobile, a camera, a network-connected device, and the like, and the publication is a for-sale publication. In one example embodiment, information (also known hereinafter as “details”) associated with the device is obtained. The information may include a brand of the device, a manufacturer of the device, a model number, a serial number, a processing speed, a storage capacity, a condition, an age, an accumulated usage, a color, a size, a weight, a product review, and the like. The information may be obtained from the device itself, from a remote database (e.g., via a website), from pictures of the device, and the like. For example, information associated with the device may be obtained from the device's operating system, a database, or other data structure in the device. The information may be obtained from a website of a manufacturer of the device, a reviewer of the device, a seller of the device, and the like. In one example embodiment, information, such as a model number, obtained from a user and/or from the device, is used to access information on the device located at a remote location, such as a remote website.

In one example embodiment, an image of the device or a similar device (such as another instance of the same model device) is obtained. The image may be processed to improve the quality of the image and/or determine information associated with the device, as described more fully below. If the image is of the device, this may include identifying a condition of the device; identifying scratches or other damage to the device; identifying the manufacturer, brand, model, and storage capacity of the device; and the like from the image of the device.

In one example embodiment, a publication is automatically created for the device based on the obtained information. The publication may include portions of the information obtained on the device, one or more images (of the device or a similar device), and the like. A user may optionally be provided with an ability to revise the publication and/or provide additional information for the publication. In one example embodiment, the publication is automatically submitted to, for example, a publication system, such as the electronic publication system of eBay Inc. of San Jose, Calif.

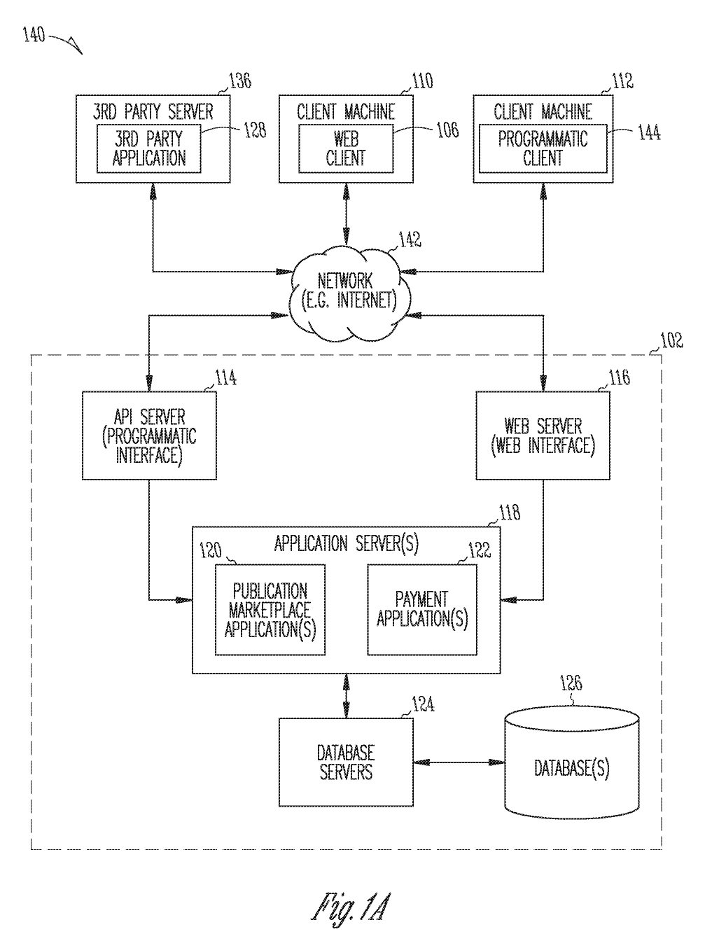

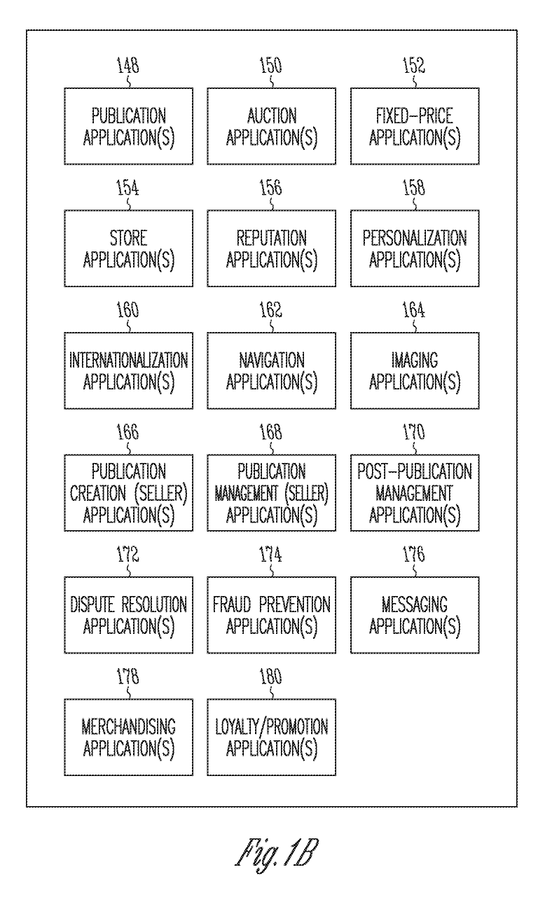

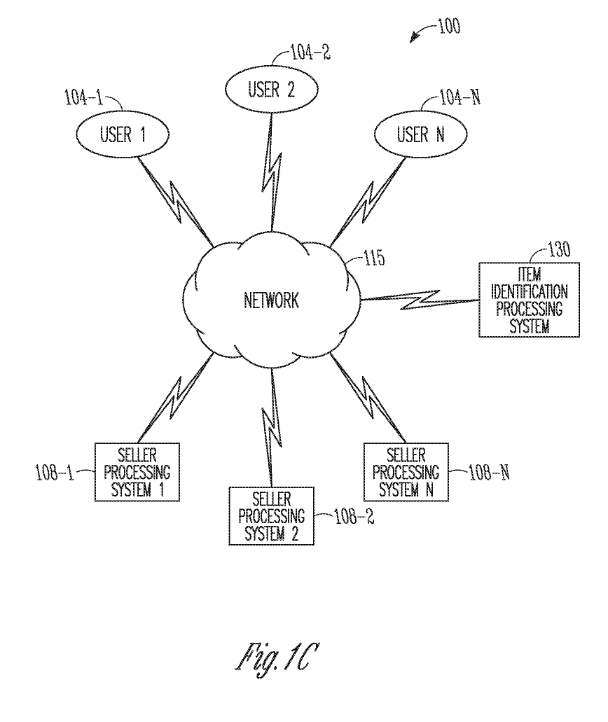

FIG. 1A is a network diagram depicting a client-server system 140, within which one example embodiment may be deployed. A networked system 102, in the example forms of a network-based publication system, provides server-side functionality, via a network 142 (e.g., the Internet or a wide area network (WAN)), to one or more clients. FIG. 1A illustrates, for example, a web client 106 (e.g., a browser, such as the Internet Explorer® browser developed by Microsoft® Corporation of Redmond, Wash. State) and a programmatic client 144 executing on respective client machines 110 and 112.

An application program interface (API) server 114 and a web server 116 are coupled to, and provide programmatic and web interfaces respectively to, one or more application servers 118. The application servers 118 host one or more publication marketplace applications 120 and payment applications 122. The application servers 118 are, in turn, shown to be coupled to one or more database servers 124 that facilitate access to one or more databases 126.

The publication marketplace applications 120 provide a number of publication functions and services to users who access the networked system 102. The payment applications 122 likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the publication marketplace applications 120. While the publication marketplace and payment applications 120 and 122 are shown in FIG. 1.A to both form part of the networked system 102, it will be appreciated that, in alternative embodiments, the payment applications 122 may form part of a payment service that is separate and distinct from the networked system 102.

Further, while the client-server system 140 shown in FIG. 1A employs a client-server architecture, the embodiments are, of course, not limited to such an architecture, and could equally well find application in a distributed, or peer-to-peer, architecture system, for example. The various publication marketplace and payment applications 120 and 122 could also be implemented as standalone software programs, which do not necessarily have networking capabilities.

The web client 106 accesses the various publication marketplace and payment applications 120 and 122 via the web interface supported by the web server 116. Similarly, the programmatic client 144 accesses the various services and functions provided by the publication marketplace and payment applications 120 and 122 via the programmatic interface provided by the API server 114. The programmatic client 144 may, for example, be a seller application (e.g., the Turbo Lister application developed by eBay Inc., of San Jose, Calif.) to enable sellers to author and manage publications on the networked system 102 in an offline manner, and to perform batch-mode communications between the programmatic client 144 and the networked system 102.

FIG. 1A also illustrates a third-party application 128, executing on a third-party server machine 136, as having programmatic access to the networked system 102 via the programmatic interface provided by the API server 114. For example, the third-party application 128 may, utilizing information retrieved from the networked system 102, support one or more features or functions on a website hosted by the third party. The third-party website may, for example, provide one or more promotional, publication, or payment functions that are supported by the relevant applications of the networked system 102.

FIG. 1B is a block diagram illustrating example publication marketplace and payment applications 120 and 122 that, in one example embodiment, are provided as part of application server(s) 118 in the networked system 102. The applications 120 and 122 may be hosted on dedicated or shared server machines (not shown) that are communicatively coupled to enable communications between server machines. The applications 120 and 122 themselves are communicatively coupled (e.g., via appropriate interfaces) to each other and to various data sources, so as to allow information to be passed between the applications 120 and 122 or so as to allow the applications 120 and 122 to share and access common data. The applications 120 and 122 may furthermore access one or more databases 126 via the database servers 124.

The networked system 102 may provide a number of publication and price-setting mechanisms whereby a seller may list (or publish information concerning) goods or services for sale, a buyer can express interest in or indicate a desire to purchase such goods or services, and a price can be set for a transaction pertaining to the goods or services. To this end, the publication marketplace and payment applications 120 and 122 are shown to include at least one publication application 148 and one or more auction applications 150, which support auction-format publication and price setting mechanisms (e.g., English, Dutch, Vickrey, Chinese, Double, Reverse auctions). The various auction applications 150 may also provide a number of features in support of such auction-format publications, such as a reserve price feature whereby a seller may specify a reserve price in connection with a publication and a proxy-bidding feature whereby a bidder may invoke automated proxy bidding.

A number of fixed-price applications 152 support fixed-price publication formats (e.g., the traditional classified advertisement-type publication or a catalogue publication) and buyout-type publications. Specifically, buyout-type publications (e.g., including the Buy-It-Now (BIN) technology developed by eBay Inc., of San Jose, Calif.) may be offered in conjunction with auction-format publications, and allow a buyer to purchase goods or services, which are also being offered for sale via an auction, for a fixed-price that is typically higher than the starting price of the auction.

Store applications 154 allow a seller to group publications within a “virtual” store, which may be branded and otherwise personalized by and for the seller. Such a virtual store may also offer promotions, incentives, and features that are specific and personalized to a relevant seller.

Reputation applications 156 allow users who transact, utilizing the networked system 102, to establish, build, and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 156 allow a user (e.g., through feedback provided by other transaction partners) to establish a reputation within the networked system 102 over time. Other potential trading partners may then reference such a reputation for the purposes of assessing credibility and trustworthiness.

Personalization applications 158 allow users of the networked system 102 to personalize various aspects of their interactions with the networked system 102. For example, a user may, utilizing an appropriate personalization application 158, create a personalized reference page at which information regarding transactions to which the user is (or has been) a party may be viewed. Further, a personalization application 158 may enable a user to personalize publications and other aspects of their interactions with the networked system 102 and other parties.

The networked system 102 may support a number of publications that are customized, for example, for specific geographic regions. A version of the networked system 102 may be customized for the United Kingdom, whereas another version of the networked system 102 may be customized for the United States. Each of these versions may operate as an independent publication or may be customized (or internationalized) presentations of a common underlying publication. The networked system 102 may accordingly include a number of internationalization applications 160 that customize information (or the presentation of information by the networked system 102) according to predetermined criteria (e.g., geographic, demographic or publication criteria). For example, the internationalization applications 160 may be used to support the customization of information for a number of regional websites that are operated by the networked system 102 and that are accessible via respective web servers 116.

Navigation of the networked system 102 is facilitated by one or more navigation applications 162. For example, a search application (as an example of a navigation application 162) enables keyword searches of publications published via the networked system 102. A browse application allows users to browse various category, catalogue, or inventory data structures according to which publications may be classified within the networked system 102. Various other navigation applications 162 may be provided to supplement the search and browsing applications.

In order to make publications available via the networked system 102 as visually informing and attractive as possible, the applications 120 and 122 include one or more imaging applications 164, which users utilize to upload images for inclusion within publications. The imaging application 164 also operates to incorporate images within viewed publications. The imaging applications 164 may also support one or more promotional features, such as image galleries that are presented to potential buyers. For example, sellers may pay an additional fee to have an image included within a gallery of images for promoted items.

Publication creation applications 166 allow sellers to conveniently author publications pertaining to goods or services that they wish to transact via the networked system 102, and publication management applications 168 allow sellers to manage such publications. Specifically, where a particular seller has authored or published a large number of publications, the management of such publications may present a challenge. The publication management applications 168 provide a number of features (e.g., auto-relisting, inventory level monitors) to assist the seller in managing such publications. One or more post-publication management applications 170 also assist sellers with a number of activities that typically occur post-publication. For example, upon completion of an auction facilitated by one or more auction applications 150, a seller may wish to leave feedback regarding a particular buyer. To this end, a post-publication management application 170 may provide an interface to one or more reputation applications 156, so as to allow the seller conveniently to provide feedback regarding multiple buyers to the reputation applications 156.

Dispute resolution applications 172 provide mechanisms whereby disputes arising between transacting parties may be resolved. For example, the dispute resolution applications 172 may provide guided procedures whereby the parties are guided through a number of steps in an attempt to settle a dispute. In the event that the dispute cannot be settled via the guided procedures, the dispute may be escalated to a third-party mediator or arbitrator.

A number of fraud prevention applications 174 implement fraud detection and prevention mechanisms to reduce the occurrence of fraud within the networked system 102.

Messaging applications 176 are responsible for the generation and delivery of messages to users of the networked system 102 (e.g., messages advising users regarding the status of publications at the networked system 102 (e.g., providing “outbid” notices to bidders during an auction process or to provide promotional and merchandising information to users)). Respective messaging applications 176 may utilize any one of a number of message delivery networks and platforms to deliver messages to users. For example, messaging applications 176 may deliver electronic mail (e-mail), instant message (IM), Short Message Service (SMS), text. facsimile, or voice (e.g., voice over IP (VoIP)) messages via the wired (e.g., the Internet), plain old telephone service (POTS), or wireless (e.g., mobile, cellular, WiMAX) networks 142.

Merchandising applications 178 support various merchandising functions that are made available to sellers to enable sellers to increase sales via the networked system 102. The merchandising applications 178 also operate the various merchandising features that may be invoked by sellers, and may monitor and track the success of merchandising strategies employed by sellers. The networked system 102 itself, or one or more parties that transact via the networked system 102, may operate loyalty programs that are supported by one or more loyalty/promotion applications 180. For example, a buyer may earn loyalty or promotion points for each transaction established and/or concluded with a particular seller, and be offered a reward for which accumulated loyalty points can be redeemed.

FIG. 1C shows a block diagram of an example system 100 for obtaining information on an item and generating an item publication, in accordance with an example embodiment. In one example embodiment, the system 100 comprises one or more user devices 104-1, 104-2 and 104-N (known as user devices 104 hereinafter), one or more optional seller processing systems 108-1, 108-2 and 108-N (known as seller processing systems 108 hereinafter), an item identification processing system 130, and a network 115. Each user device (e.g., 104-1) may be a personal computer (PC), a mobile phone, a personal digital assistant (PDA), a refrigerator, an automobile, a camera, a network-connected device, or any other appropriate computer device. The user device 104 may be the item that is the subject of the information to be obtained and the item publication to be generated.

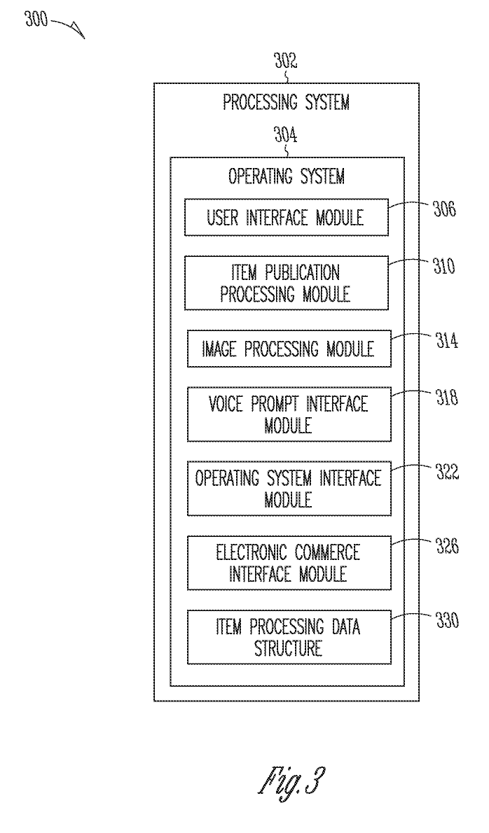

Each user device (104-1, 104-2, 104-N) may include a user interface module 306, described more fully below in conjunction with FIG. 3. In one example embodiment, the user interface module 306 may comprise a web browser program. In one example embodiment, each user device (104-1, 104-2, 104-N) may comprise a device, such as a switch, microphone, and the like, for triggering the generation of an item publication. For example, a user may speak a command to generate the item publication that is received by the microphone. Although a detailed description is only illustrated for user device 104-1, it is noted that each of the other user devices (e.g., user device 104-2 through user device 104-N) may have corresponding elements with the same functionality.

The optional seller processing systems 108 and the item identification processing system 130 may be a server, client, or other processing device that includes an operating system for executing software instructions. The optional seller processing systems 108 provide items for sale to a consumer, and may facilitate the search for and purchase of the items by a variety of consumers.

The network 115 may be a local area network (LAN), a wireless network, a metropolitan area network (MAN), a wide area network (WAN), a wireless network, a network of interconnected networks, the public switched telephone network (PSTN), and the like.

Each user device 104 may receive a query for item information from a user via an input device such as keyboard, mouse, electronic pen, etc. An item may comprise a product and/or a service and the corresponding information may be in the form of an item publication.

The item identification processing system 130 of an online publication system may store and/or obtain information related to items available for sale. Each item publication may comprise a detailed description for the item, a picture of the item, attributes of the item, and the like. The item associated with the item publication may be a good or product (e.g., a tablet computer) or a service (e.g., a round of golf or appliance repair) that may be transacted (e.g., exchanging, sharing information about, buying, selling, making a bid on, and the like). The item publication may also include a title, a category (e.g., electronics, sporting goods, books, antiques, and the like), and attributes and tag information (e.g., color, size, and the like).

Referring back to the user device 104-1, the query received from the user of user device 104-1 may comprise one or more keywords. The user device 104-1 may transmit the query to the item identification processing system 130 via the network 115. The item identification processing system 130 may attempt to match the query keywords with the title, the category, the tag information, and/or any other field in the item publication using a search engine and may identify one or more item publications that satisfy the query. The item identification processing system 130 may retrieve and then sort the item publications in the search result in a known manner.

The search result list may comprise a list of available items of varying degrees of relevance to the particular product or product type for which the consumer is searching. The consumer may select from the search result list one or more items that correspond more closely to the consumer's search intention, for example, in order to obtain additional information on the item, or the consumer may apply one or more filters and may resubmit the query.

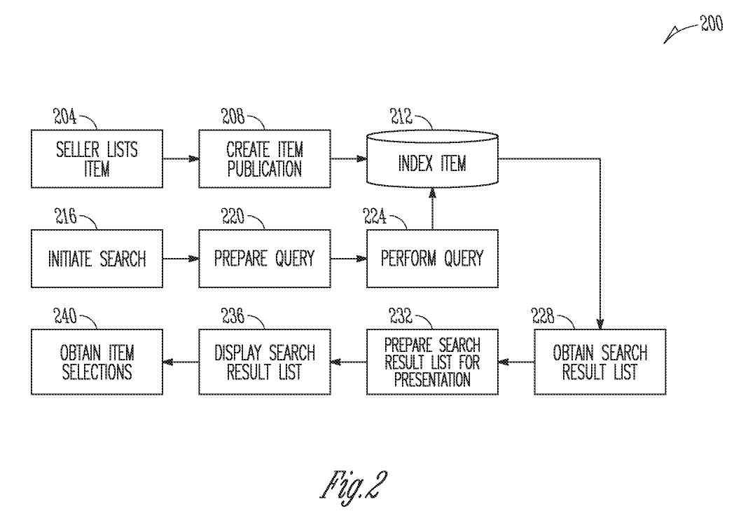

FIG. 2 shows a flowchart for an example method 200 for publication, indexing, and searching for a product or service, in accordance with an example embodiment. In one example embodiment, a seller may list an item for sale (operation 204). The seller may, for example, select a category for the item, submit a description of the item, submit a picture of the item, manually set attributes of the item, and the like. In one example embodiment, a seller simply requests that the device be listed for sale by, for example, clicking on a “sell this” icon,

An item publication is created in, for example, an item publication database (operation 208). The publication may include, for example, attributes of the item and terms of the sale offer. During the item publication operation 208, an identification number for the item publication may be assigned, and the publication may be authenticated and scanned to check for conformance with one or more publication policies. The listed item is indexed (operation 212) in a known manner to facilitate future searches for the item.

A consumer launches a search or query for one or more items (operation 216). For example, a consumer may initiate a search using the keywords “smartphone.” A corresponding query is prepared (operation 220). For example, a spell check may be performed on the query terms and a search expression may be generated based on the provided search terms.

The query is executed on, for example, the items that have been indexed in the system (operation 224). For example, the prepared query is matched against the index that was updated during operation 212.

In response to the execution of the query, a search result list is obtained (operation 228). The search result list may be analyzed and an auto-filter mechanism may be enabled or disabled based, for example, on the obtained search result list. For example, the auto-filter mechanism may be enabled if the count of items in the search result list exceeds a threshold value or if the auto-filter mechanism has been enabled by a user.

The search result list is prepared for presentation (operation 232). For example, the search result list may be filtered, sorted, ranked, or formatted based, for example, on the analysis of the search result list performed and based on an identified set of search filters.

The prepared search result list is displayed (operation 236). In response to reviewing the displayed search result list, one or more item selections from one or more displayed item pages may be obtained from a user (operation 240).

FIG. 3 shows a block diagram of an example apparatus 300 for determining details regarding an item and generating an item publication, in accordance with an example embodiment. The apparatus 300 is shown to include a processing system 302 that may be implemented on a client or other processing device that includes an operating system 304 for executing software instructions. In accordance with an example embodiment, the apparatus 300 may include a user interface module 306, an item publication processing module 310, an image processing module 314, a voice prompt interface module 318, an operating system interface module 322, an electronic commerce interface module 326, and an item processing data structure 330.

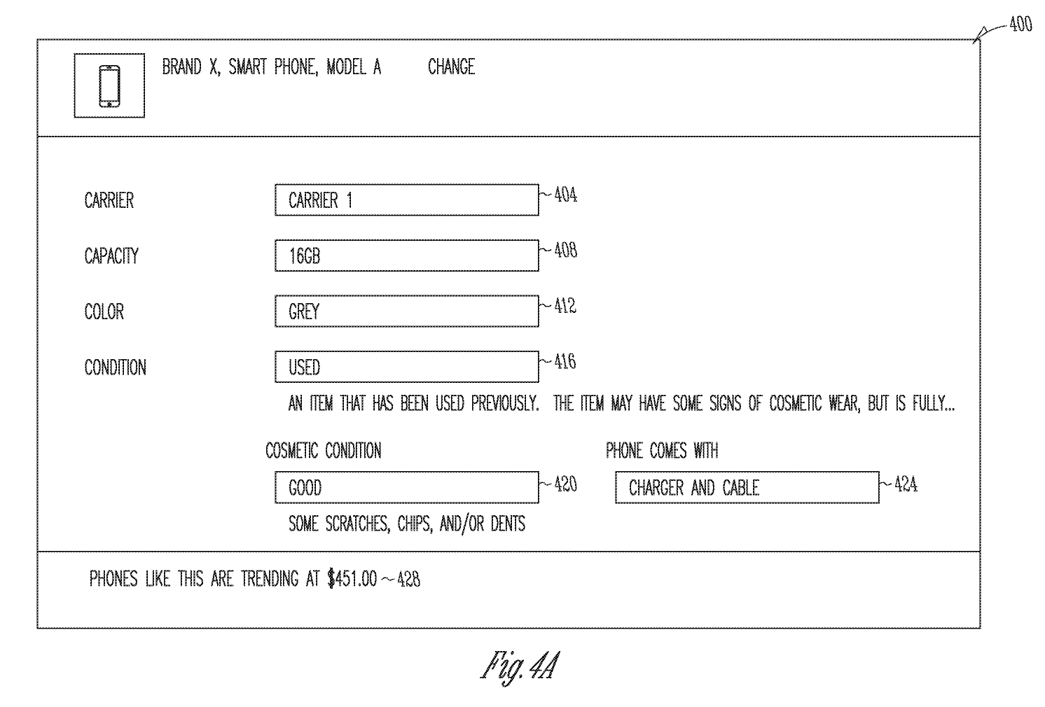

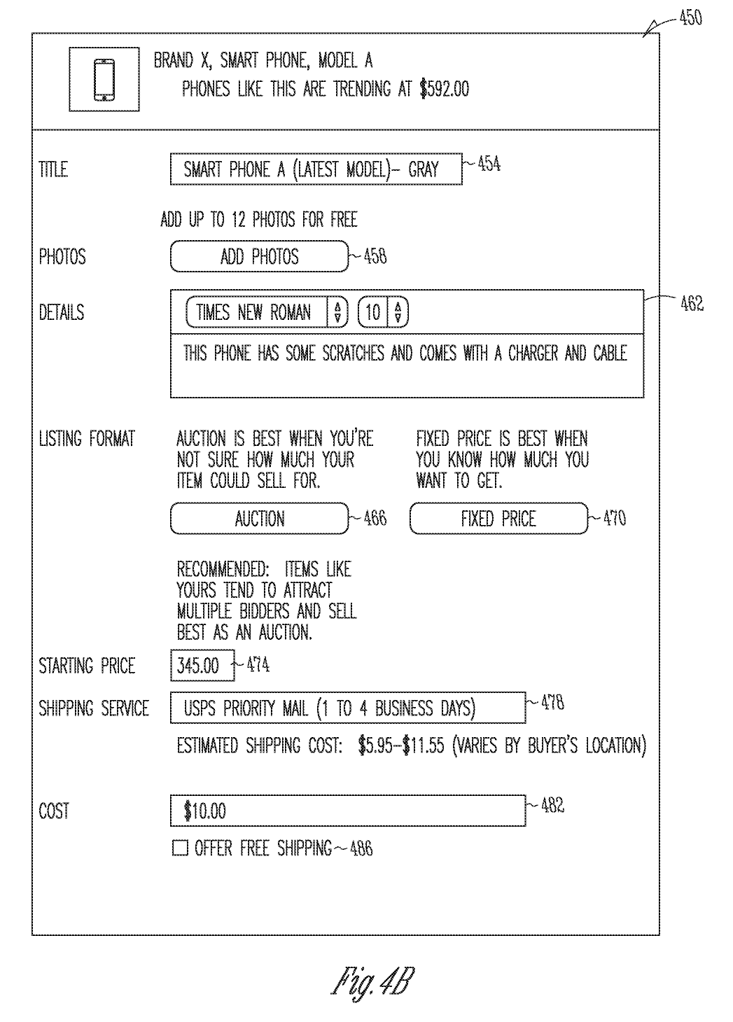

The user interface module 306 provides user interfaces that, for example, obtain requests from users to create an item publication and provide an ability for a user to enter information on the item, as described more fully below in conjunction with FIGS. 4A and 4B. The user interface module 306 may present, via a user interface, the item publication to the user and optionally provides the user with an ability to revise the item publication. The user interface may be presented on the item to be listed for sale, or may be presented on an associated item, such as a smartphone, tablet computer, and the like.

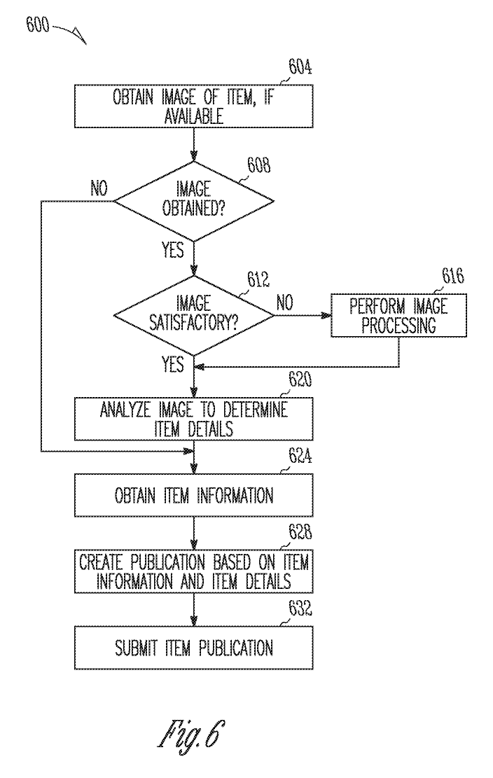

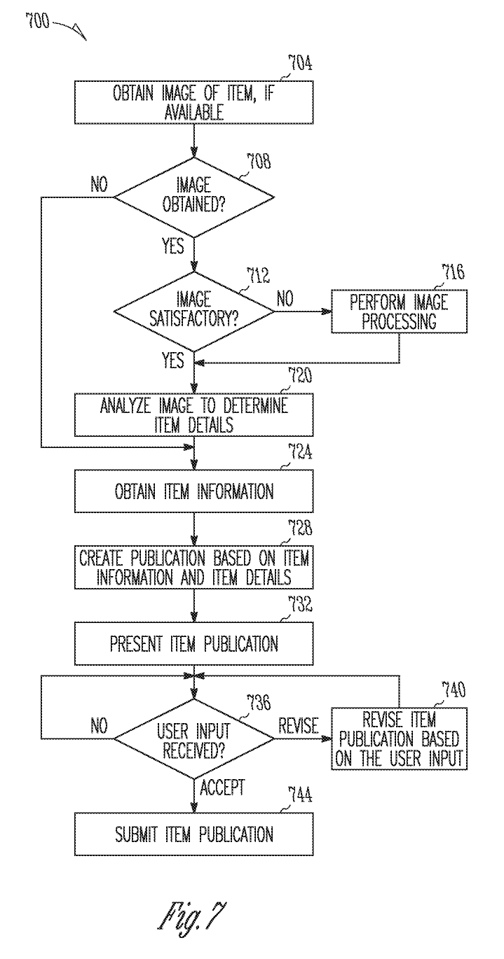

The item publication processing module 310 obtains information on an item and creates an item publication based on the obtained information, as described more fully below in conjunction with FIGS. 6 and 7. The item publication processing module 310 coordinates activities with the user interface module 306, the image processing module 314, the voice prompt interface module 318, the operating system interface module 322, and the electronic commerce interface module 326. The item publication processing module 310 maintains information associated with the item in the item processing data structure 330.

The image processing module 314 processes an image of a device to improve the quality of the image, such as by rotating, cropping, and/or adjusting the brightness, hue, color, and/or sharpness of the image. The image processing module 314, optionally, processes the image to, for example, identify a condition of the item, identify scratches or other damage to the item, identify the manufacturer, brand, model, and storage capacity of the item, and the like.

The voice prompt interface module 318 generates voice prompts to instruct and/or guide a user in creating an item publication. The voice prompt may ask if a user desires to list an item for sale and may perform speech recognition to recognize a verbal command by the user to list the item for sale.

The operating system interface module 322 interfaces with the device's operating system and/or data structures of the device to obtain information on the device. The obtained information may be automatically entered in the publication corresponding to the device.

The electronic commerce interface module 326 interfaces with, for example, an electronic commerce publication system to submit the item publication for publishing.

FIGS. 4A and 4B show representations of example user interfaces 400, 450 for reviewing and revising an item publication, in accordance with an example embodiment. In one example embodiment, the user interfaces 400, 450 may be utilized by the user device 104 to enable a user to view an item publication that was automatically generated and make changes to the item publication.

For example, information for a smartphone may be entered or updated via the user interfaces 400, 450. In particular, a carrier associated with the smartphone may be viewed or entered via a carrier field 404, a storage capacity of the smartphone may be viewed or entered via a storage capacity field 408, a color of the smartphone may be viewed or entered via a color field 412, and a condition of the smartphone may be viewed or entered via a condition field 416. A cosmetic condition of the smartphone may be viewed or entered in a cosmetic field 420 and accessories that come with the smartphone may be viewed or entered via an accessory field 424. The information entered in fields 404-424 may be manually entered or may be automatically entered, as described above. For example, an image of the item may be obtained, the image may be analyzed to determine the information associated with the fields 404-424, and the fields 404-424 may be auto-populated. In one example embodiment, a suggested price for the smartphone is displayed via suggested price field 428. In one example embodiment, the price is automatically selected by the system 100.

Referring now to FIG. 4B, a user interface 450 for generating or revising an item publication is shown. In one example embodiment, a title for the item publication may be viewed, entered, or both via a title field 454. The title may be automatically generated from the information entered in other fields, such as fields 404-424. Images of the smartphone may be automatically obtained (such as from a website of a manufacturer of the item) or may be provided by selecting an add photos button 458 as described below in conjunction with FIGS. 6 and 7. Details describing the smartphone may be viewed or entered via a details field 462. For example, a description of the smartphone as having some scratches, chips, and/or dents may be viewed or entered via details field 462. As in the case of fields 404-424, an image of the item may be obtained, the image may be analyzed to generate a description of the smartphone, and the details field 462 may be auto-populated. The type of item publication, such as auction or fixed price, may be automatically selected by the system 100 based on the results of previous item publications or based on a user profile. The type of item publication, such as auction or fixed price, may be selected via an auction button 466 or a fixed price button 470, respectively, or may be automatically selected by the system based on a user's profile information or based on the type of item publication associated with the highest conversion rate (executed transactions) of similar items in the past. The starting price for an auction or a fixed price sale may be viewed or entered via a price field 474, and the shipping service may be viewed or entered via a shipping service field 478. The shipping cost is entered via a shipping cost field 482, or free shipping may be offered by selecting a free shipping box 486. In one example embodiment, the price, the shipping service, the shipping costs for the buyer, and the like may be suggested or selected by the system 100.

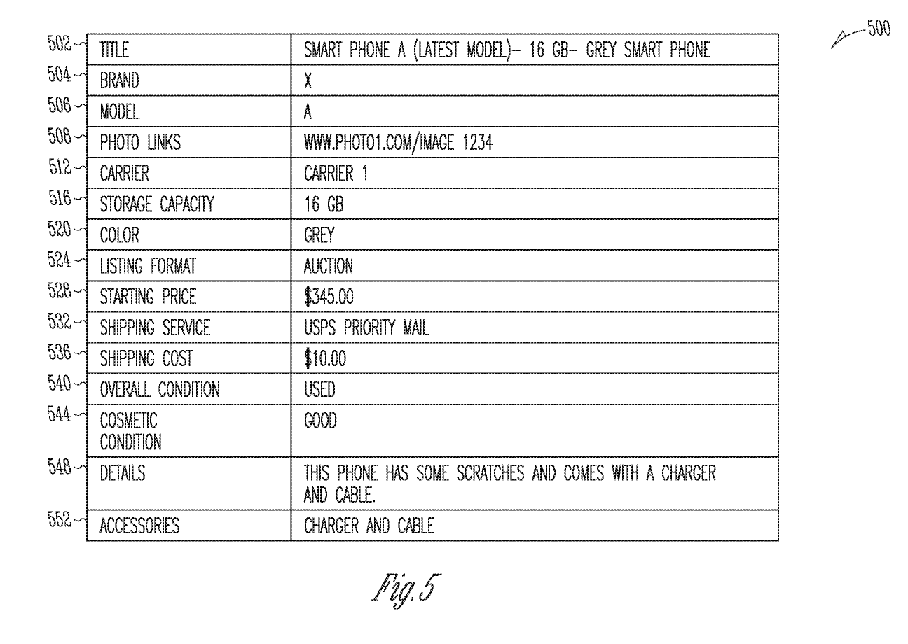

FIG. 5 shows an example data structure 500 for maintaining information associated with an item, in accordance with an example embodiment. In one example embodiment, the data structure 500 is accessed by, for example, the item publication processing module 310 and may be stored in a database (not shown).

In one example embodiment, the data structure 500 comprises one or more fields, where each field comprises free form text, data of a particular data type, and the like. As illustrated in FIG. 5, the example data structure 500 comprises free form text fields, such as a title field 502 (for storing the entry of the title field 454), an overall condition field 540 (for storing the entry of the condition field 416), a. cosmetic condition field 544 (for storing the entry of the cosmetic field 420), a details field 548 (for storing the entry of the details field 462), and an accessories field 552 (for storing the entry of the accessory field 424). The example data structure 500 comprises a carrier field 512 (for storing the entry of carrier field 404), a storage capacity field 516 (for storing the entry of storage capacity field 408), a color field 520 (for storing the entry of the color field 412), a publication format field 524 (for storing the publication format), a starting price field 528 (for storing the entry of the suggested price field 428), a shipping service field 532 (for storing the entry of the shipping service field 478), and a shipping cost field 536 (for storing the entry of the shipping cost field 482). The example data structure 500 also comprises a field 508 for storing one or more links to one or more photos associated with the item, such as photographs of the item, photographs of accessories for the item, and the like.

FIG. 6 is a flowchart for an example method 600 for determining details regarding an item and generating an item publication, in accordance with an example embodiment. In one example embodiment, one or more of the operations of the method 600 may be performed by the processing system 302.

In one example embodiment, an option to generate an item publication is presented to a user via, for example, the user interface module 306. The option may be presented, for example, as an iconic button that may be selected via the user interface module 306, as an electronic switch, and the like. In one example embodiment, the method 600 may present a voice prompt indicating that the item may be listed for sale, and the user's response may be monitored with a microphone. If the option to generate an item publication is selected, the method 600 is executed.

In one example embodiment, an archived image of the device is obtained, if available (operation 604). A test is performed to determine if an image was obtained (operation 608). If an image was not obtained, the method 600 proceeds with operation 624. If an image was obtained, a test is performed to determine if the image quality is satisfactory (operation 612). For example, the image may be processed by the image processing module 314 to determine if the brightness, contrast, sharpness, color, hue, and the like is satisfactory.

If the image quality is satisfactory, the method 600 proceeds with operation 620; otherwise, the image is processed by the image processing module 314 to improve the quality of the image, as described above (operation 616). (In one example embodiment, the cited processing is performed by a cloud-based image processing service.) The image may be processed to adjust the brightness, contrast, sharpness, color, hue, and the like of the image. The image of the device may be rotated to vertically or horizontally orient the image of the device, and/or the image may be cropped to near the perimeter of the device.

During operation 620, the image is analyzed to determine information regarding the item including, for example, identifying a condition of the item, identifying scratches or other damage to the item, identifying the manufacturer, brand, model, and storage capacity of the device, and the like. For example, the name of the manufacturer may be obtained using optical character recognition on a logo or other identifying mark on the item, the model may be determined by comparing the image of the device to archived images of various models, a scratch on the device may be recognized using image processing techniques, and the like.

Information regarding the item is obtained (operation 624). For example, the manufacturer, brand, model, storage capacity of the device, and the like may be obtained via an operating system of the device or a website of a manufacturer of the device. For example, the characteristics of the device may be stored on the device itself and may be retrieved for inclusion in the item publication. An item publication is generated using the information and determined item details (operation 628) by the item publication processing module 310. For example, the obtained information may be automatically entered in corresponding fields of an item publication template and/or data structure (such as the data structure 500), and one or more of the obtained images may be automatically attached to the image publication. The item publication is submitted to, for example, an electronic publication (operation 632).

FIG. 7 is a flowchart for an example method 700 for determining details regarding an item and generating an item publication, in accordance with an example embodiment. In one example embodiment, one or more of the operations of the method 700 may be performed by the processing system 302. Operations 704 to 728 are similar to operations 604 to 628 of method 600.

In one example embodiment, following operation 728, the created item publication may be presented to a user for review (if, for example, instructed to by a user profile) (operation 732). For example, the user interface module 306 may present the item publication to the user for review. A test is performed by the item publication processing module 310 to determine if user input has been received following presentation of the item publication (operation 736). If no user input is received, the method 700 proceeds with operation 736. If revisions to the item publication are received, the item publication is revised according to the user input (operation 740) and the method 700 proceeds with operation 736. If an acceptance of the created item publication is received, the item publication is submitted to, for example, an electronic publication (operation 744). If no user input is received for a predefined time period (e.g., three minutes), an error message may be issued and the method 700 ends.

In one example embodiment, a user is required to exercise a user authentication procedure during operation 736 in order to submit the publication. Authentication may be performed, for example, using a user token, a user identifier and password, biometric information, and the like.

In one example embodiment, one or more operations of the method 600 or 700 is performed on the device being listed for sale. In one example embodiment, one or more operations of the method 600 or 700 is performed on a device other than the device to be listed for sale. For example, a user may select a refrigerator to sell from a list of available items on another device, such as a tablet computer, and the tablet computer may perform one or more operations of the method 600 or 700 in order to list the refrigerator for sale.

In one example embodiment, the generation of an item publication may be triggered using the device being listed for sale (such as by issuing a voice command to the device being listed for sale) and the device being listed for sale may issue a command to another device to generate the item publication. For example, a voice command may be issued in an automobile that is to be listed for sale and the automobile may send a request to a server, tablet computer, or other entity to generate the item publication.

In one example embodiment, the item publication is sent to a device (other than the device to be listed for sale) in order to be reviewed by the user. For example, an item publication for a refrigerator may be sent to a tablet computer to be reviewed by the user.

Although certain examples are shown and described here, other variations exist and are within the scope of the invention. It will be appreciated, by those of ordinary skill in the art, that any arrangement, which is designed or arranged to achieve the same purpose, may be substituted for the specific embodiments shown. This application is intended to cover any adaptations or variations of the example embodiments of the invention described herein. It is intended that this invention be limited only by the claims, and the full scope of equivalents thereof.

### Example Mobile Device

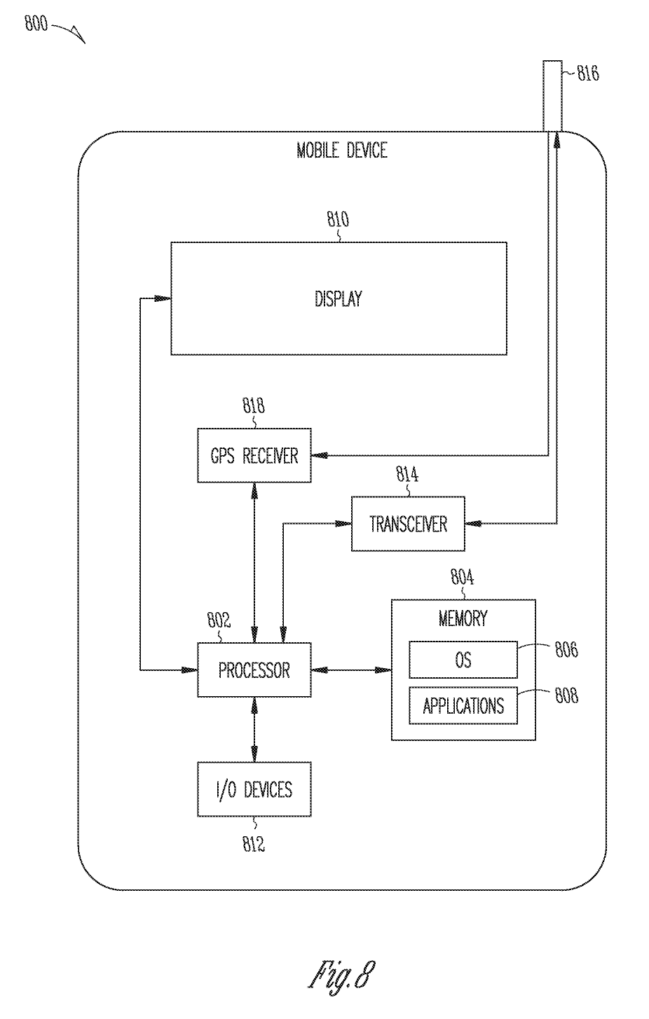

FIG. 8 is a block diagram illustrating a mobile device 800, according to an example embodiment. The mobile device 800 may include a processor 802. The processor 802 may be any of a variety of different types of commercially available processors suitable for mobile devices 800 (for example, an XScale architecture microprocessor, a microprocessor without interlocked pipeline stages (MIPS) architecture processor, or another type of processor 802). A memory 804, such as a random access memory (RAM), a flash memory, or other type of memory, is typically accessible to the processor 802. The memory 804 may be adapted to store an operating system (OS) 806, as well as application programs 808, such as a mobile location-enabled application that may provide location-based services (LBSs) to a user. The processor 802 may be coupled, either directly or via appropriate intermediary hardware, to a display 810 and to one or more input/output (I/O) devices 812, such as a keypad, a touch panel sensor, a microphone, and the like. Similarly, in some embodiments, the processor 802 may be coupled to a transceiver 814 that interfaces with an antenna 816. The transceiver 814 may be configured to both transmit and receive cellular network signals, wireless data signals, or other types of signals via the antenna 816, depending on the nature of the mobile device 800. Further, in some configurations, a Global Positioning System (GPS) receiver 818 may also make use of the antenna 816 to receive GPS signals.

### Modules, Components and Logic

Certain embodiments are described herein as including logic or a number of components, modules, or mechanisms. Modules may constitute either software modules(e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at leak partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, for example, in a machine-readable medium for execution by, or to control the operation of data processing apparatus, for example, a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, for example, a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

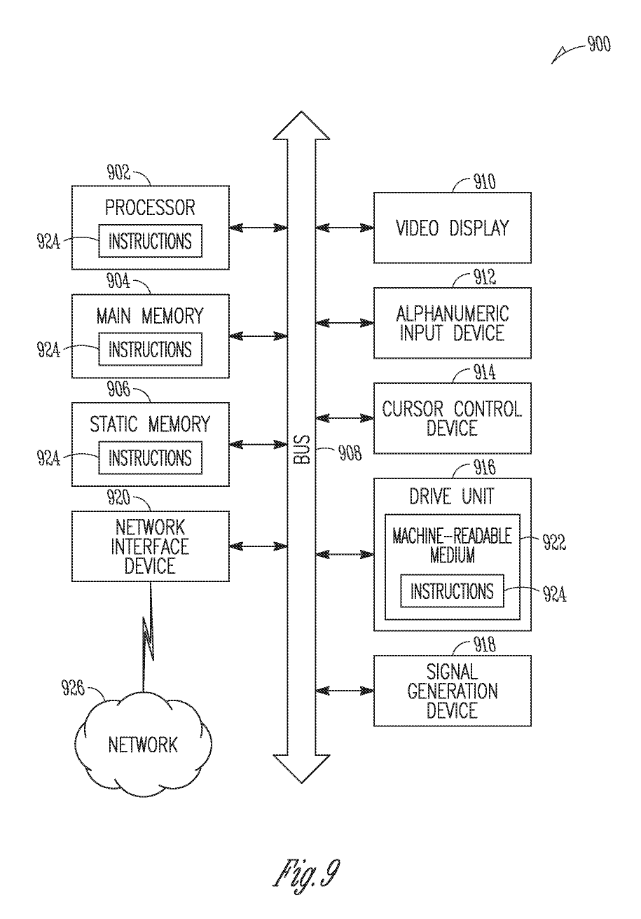

FIG. 9 is a block diagram of a machine within which instructions may be executed for causing the machine to perform any one or more of the methodologies discussed herein. In one example embodiment, the machine may be the example apparatus 300 of FIG, 3 for creating an item publication. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (CiPU) or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a user interface (UI) navigation (or cursor control) device 914 (e.g., a mouse), a disk drive unit 916, a signal generation device 918 (e.g., a speaker) and a network interface device 920.

### Machine-Readable Medium

The drive unit 916 includes a machine-readable medium 922 on which is stored one or more sets of data structures (e.g., software) and instructions 924 embodying or utilized by any one or more of the methodologies or functions described herein. The instructions 924 may also reside, completely or at least partially, within the main memory 904 and/or within the processor 902 during execution thereof by the computer system 900, the main memory 904 and the processor 902 also constituting machine-readable media 922. Instructions 924 may also reside within the static memory 906.

While the machine-readable medium 922 is shown in an example embodiment to be a single medium, the term “machine-readable medium” may include a single medium or multiple media (e.g., a centralized or distributed database, and/or associated caches and servers) that store the one or more data structures or instructions 924. The term “machine-readable medium” shall also be taken to include any tangible medium that is capable of storing, encoding or carrying instructions 924 for execution by the machine and that cause the machine to perform any one or more of the methodologies of the present invention, or that is capable of storing, encoding or carrying data structures utilized by or associated with such instructions 924. The term “machine-readable medium” shall accordingly be taken to include, but not be limited to, solid-state memories, and optical and magnetic media. Specific examples of machine-readable media 922 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

Furthermore, the machine-readable medium 622 is non-transitory in that it does not embody a propagating or transitory signal. However, labeling the machine-readable medium 622 as “non-transitory” should not be construed to mean that the medium is incapable of movement—the medium should be considered as being transportable from one physical location to another. Additionally, since the machine-readable medium 622 is tangible, the medium may be considered to be a machine-readable device. Furthermore, the machine-readable medium does not comprise any transitory signals.

### Transmission Medium

The instructions 924 may further be transmitted or received over a communications network 926 using a transmission medium. The instructions 924 may be transmitted using the network interface device 920 and any one of a number of well-known transfer protocols (e.g., hypertext transfer protocol (HTTP)). Examples of communication networks 926 include a local area network (“LAN”), a wide area network (“WAN”), the Internet, mobile telephone networks, plain old telephone (POTS) networks, and wireless data networks (e.g., WiFi and WiMax networks). The term “transmission medium” shall be taken to include any intangible medium that is capable of storing, encoding or carrying instructions 924 for execution by the machine, and includes digital or analog communications signals or other intangible media to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component Similarly, structures and functionality presented as a single component may be implemented as separate components. These and other variations, modifications, additions, and improvements fall within the scope of the subject matter herein.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Unless specifically stated otherwise, discussions herein using words such as “processing,” “computing,” “calculating,” “determining,” “presenting,” “displaying,” or the like may refer to actions or processes of a machine e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. An apparatus for creating an item publication, the apparatus comprising:
a publication processing module, implemented using at least one processor, to obtain specification information on an item from one or more distributed data structures, at least a portion of the specification information being extracted from one or more images of the item using image processing, and to create the item publication in response to a one-click command.

2. The apparatus of claim 1, wherein the publication processing module is further configured to electronically obtain one or more item details from the item.

3. The apparatus of claim 2, wherein the item details are electronically obtained from an operating system of the item or a data structure associated with the item.

4. The apparatus of claim 1, wherein the publication processing module is further configured to cause presentation of the item publication to a user for review and revision via a user interface displaying the item publication.

5. The apparatus of claim 1, wherein the publication processing module is further configured to obtain the one or more images of the item and process at least one of the one or more of the images to identify one or more of a brand, a manufacturer, a model number, a serial number, a processing speed, a storage capacity, a condition, an age, an accumulated usage, a color, a size, a weight, a product review, a scratch, or damage to the item.

6. The apparatus of claim 5, wherein the one or more images are obtained from a camera within the item or a camera within another item.

7. The apparatus of claim 1, wherein the publication processing module is further configured to automatically submit the created item publication in response to the one-click command.

8. A method for creating an item publication, the method comprising:
obtaining specification information on an item from one or more distributed data structures, at least a portion of the specification information being extracted from one or more images of the item using image processing; and
creating the item publication in response to a one-click command.

9. The method of claim 8, further comprising electronically obtaining one or more item details from the item.

10. The method of claim 9, wherein the item details are electronically obtained from an operating system of the item or a data structure associated with the item.

11. The method of claim 8, further comprising causing presentation of the item publication to a user for review and revision via a user interface displaying the item publication.

12. The method of claim 8, further comprising obtaining the one or more images of the item and processing at least one of the one or more of the images to identify one or more of a brand, a manufacturer, a model number, a serial number, a processing speed, a storage capacity, a condition, an age, an accumulated usage, a color, a size, a weight, a product review, a scratch, or damage to the item.

13. The method of claim 12, wherein the one or more images are obtained from a camera within the item or a camera within another item.

14. The method of claim 8, further comprising automatically submitting the created item publication in response to the one-click command.

15. A non-transitory computer-readable medium embodying instructions that, when executed by one or more processors, causes the one or more processors to perform operations comprising:
obtaining specification information on an item from one or more distributed data structures, at least a portion of the specification information being extracted from one or more images of the item using image processing; and
creating the item publication in response to a one-click command.

16. The non-transitory computer-readable medium of claim 15, the operations further comprising electronically obtaining one or more item details from the item.

17. The non-transitory computer-readable medium of claim 15, the operations further comprising causing presentation of the item publication to a user for review and revision via a use interface displaying the item publication.

18. The non-transitory computer-readable medium of claim 15, the operations further comprising obtaining the one or more images of the item and processing at least one of the one or more of the images to identify one or more of a brand, a manufacturer, a model number, a serial number, a processing speed, a storage capacity, a condition, an age, an accumulated usage, a color, a size, a weight, a product review, a scratch, or damage to the item.

19. The non-transitory computer-readable medium of claim 18, wherein the one or more images are obtained from a camera within the item or a camera within another item.

20. The non-transitory computer-readable medium of claim 15, the operations further comprising automatically submitting the created item publication in response to the one-click command.
